(19) United States
(12) Patent Application Publication
(10) Pub. No.: US 2011/0061368 A1
(43) Pub. Date: Mar. 17, 2011

(54) PARTICULATE MATTER SENSOR AND EXHAUST GAS PURIFYING APPARATUS

(75) Inventors: Fumishige Miyata, Ibi-Gun (JP); Takafumi Kasuga, Ibi-Gun (JP); Yasuhiro Ishii, Ibi-Gun (JP)

(73) Assignee: IBIDEN CO., LTD., Ogaki-Shi (JP)

(21) Appl. No.: 12/763,223

(22) Filed: Apr. 20, 2010

(30) Foreign Application Priority Data
Sep. 15, 2009 (JP) PCT/JP2009/066063

(51) Int. Cl. F01N 11/00; F01N 1/00; F01N 3/00; F01N 3/02; F16L 9/00; G01M 15/10

(52) U.S. Cl. 60/277; 60/324; 60/287; 60/311; 138/177; 73/23.33

(57) ABSTRACT

A particulate matter sensor includes a detection filter, a differential pressure detecting unit, an on-off valve, and a valve control unit. The detection filter is installed in an exhaust passage connected to an internal combustion engine and is configured to detect particulate matter contained in an exhaust gas passing through the exhaust passage. The differential pressure detecting unit is configured to detect a pressure difference between an upstream side and a downstream side of the detection filter. The on-off valve is installed on the upstream side of the detection filter in the exhaust passage and is configured to control a flow of the exhaust gas toward the detection filter. The valve control unit is configured to control the on-off valve to be opened and closed.

### CROSS-REFERENCE TO RELATED APPLICATIONS

The present application claims priority under 35 U.S.C. §119 to International Application No. PCT/JP2009/066063 filed on Sep. 15, 2009, the entire contents of which are incorporated herein by reference.

### BACKGROUND OF THE INVENTION

1. Field of the Invention

The present invention generally relates to a particulate matter sensor and an exhaust gas purifying apparatus.

2. Description of the Related Art

Conventionally, an exhaust gas purifying apparatus using a particulate matter capturing filter (diesel particulate filter (DPF)) made of a porous ceramic is known as a device for capturing primarily of C (carbon) particulate matter contained in exhaust gas exhausted from diesel engines (see, for example, Patent EP1916394A). In this conventional exhaust gas purifying apparatus, the particulate matter gradually deposits on the diesel particulate filter along with a continuous use of the diesel engine. Therefore, it is possible to prevent the particulate matter in the exhaust gas from being released from the diesel engine into the atmosphere. Thus, it is possible to purify the exhaust gas.

However, when the particulate matter excessively deposits on the diesel particulate filter, the particulate matter may leak into an exhaust line on a downstream side of the diesel particulate filter. Therefore, in order to diagnose the leakage of the particulate matter onto the downstream side of the diesel particulate filter, a guiding branch (diverging passage) may be connected to the exhaust line on the downstream side of the diesel particulate filter, and a detection filter may be attached to the guiding branch in order to measure concentration of the particulate matter and detect the leakage of the particulate matter onto the downstream side of the diesel particulate filter. An effective way of preventing the particulate matter from excessively depositing is supposed to be a removal with oxidation by burning the deposited particulate matters, which is deposited on the diesel particulate filter. In order to measure a deposited amount of the particulate matter on the diesel particulate filter, a guiding branch may be connected to the exhaust line on the upstream side of the diesel particulate filter to divert a part of the exhaust gas exhausted from the internal combustion engine as an sample gas, and a detection filter may be installed in the guiding branch to enable detecting (capturing) the particulate matter in the exhaust gas.

In the vicinity of the detection filter, the particulate matter sensor is provided to output signals corresponding to a pressure difference between the upstream side and the downstream side of the detection filter in the guiding branch, the concentration of the oxygen or the like in the exhaust line. The output signal of the particulate matter sensor is sent to a diagnostic device or a measurement device, and is used to diagnose the leakage of the particulate matter onto the downstream side of the diesel particulate filter or measurement of the deposited amount of the particulate matter on the diesel particulate filter. Therefore, when the conventional particulate matter sensor is used, it is possible to diagnose the leakage of the particulate matter onto the downstream side of the diesel particulate filter, or measure the deposited amount on the diesel particulate filter.

The entire contents of European Patent No. 1916394 are incorporated in the present application by reference.

### SUMMARY OF THE INVENTION

In an aspect of the embodiments of the present invention, a particulate matter sensor includes a detection filter, a differential pressure detecting unit, an on-off valve, and a valve control unit. The detection filter is installed in an exhaust passage connected to an internal combustion engine and is configured to detect particulate matter contained in an exhaust gas passing through the exhaust passage. The differential pressure detecting unit is configured to detect a pressure difference between an upstream side and a downstream side of the detection filter. The on-off valve is installed on the upstream side of the detection filter in the exhaust passage and is configured to control a flow of the exhaust gas toward the detection filter. The valve control unit is configured to control the on-off valve to be opened and closed.

Further, in another aspect of the embodiments of the present invention, an exhaust gas purifying apparatus includes a particulate matter sensor, a particulate matter capturing filter, an upstream side exhaust gas introducing unit, and a particulate matter deposit amount calculating unit. The particulate matter sensor includes a detection filter, a differential pressure detecting unit, an on-off valve, and a valve control unit. The detection filter is installed in an exhaust passage connected to an internal combustion engine and is configured to detect particulate matter contained in an exhaust gas passing through the exhaust passage. The differential pressure detecting unit is configured to detect a pressure difference between an upstream side and a downstream side of the detection filter. The on-off valve is installed on the upstream side of the detection filter in the exhaust passage and is configured to control a flow of the exhaust gas toward the detection filter. The valve control unit is configured to control the on-off valve to be opened and closed. The particulate matter capturing filter is configured to capture particulate matter contained in an exhaust gas flowing through a primary exhaust line included in the exhaust passage. The upstream side exhaust gas introducing unit is configured to introduce a part of the exhaust gas flowing through the primary exhaust line from an upstream side of the particulate matter capturing filter toward the particulate matter sensor. The particulate matter deposit amount calculating unit is configured to calculate an amount of the particulate matter depositing on the particulate matter capturing filter based on an amount of the particulate matter detected by the particulate matter sensor.

Further, in another aspect of the embodiments of the present invention, an exhaust gas purifying apparatus includes a particulate matter sensor, a particulate matter capturing filter, a downstream side exhaust gas introducing unit, and a filter failure diagnosing unit. The particulate matter sensor includes a detection filter, a differential pressure detecting unit, an on-off valve, and a valve control unit. The detection filter is installed in an exhaust passage connected to an internal combustion engine and is configured to detect particulate matter contained in an exhaust gas passing through the exhaust passage. The differential pressure detecting unit is configured to detect a pressure difference between an upstream side and a downstream side of the detection filter. The on-off valve is installed on the upstream side of the detection filter in the exhaust passage and is configured to control a flow of the exhaust gas toward the detection filter. The valve control unit is configured to control the on-off valve to be opened and closed. The particulate matter capturing filter is configured to capture particulate matter contained in an exhaust gas flowing through a primary exhaust line included in the exhaust passage. The downstream side exhaust gas introducing unit is configured to introduce a part of the exhaust gas flowing through the primary exhaust line from a downstream side of the particulate matter capturing filter toward the particulate matter sensor. The filter failure diagnosing unit is configured to diagnose the particulate matter capturing filter based on an amount of the particulate matter detected by the particulate matter sensor.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates an entire structure of an exhaust gas purifying apparatus of an embodiment of the present invention;

FIG. 2 illustrates an important portion of the exhaust gas purifying apparatus of FIG. 1;

FIG. 3 is a flowchart illustrating a control routine of driving an on-off valve of the exhaust gas purifying apparatus of FIG. 2; and

FIG. 4 illustrates the entire structure of an exhaust gas purifying apparatus of another embodiment according to the present invention.

### DESCRIPTION OF THE PREFERRED EMBODIMENTS

In order to diagnose the leakage of the particulate matter on the downstream side of the diesel particulate filter or measure the amount of the particulate matter captured by the conventional diesel particulate filter (EP0916394A), it is necessary to guide the exhaust gas to the above detection filter. Under a structure in which the detection filter is constantly exposed to the exhaust gas passing through the exhaust line, an increment rate of the particulate matter depositing on the detection filter is relatively high. As a result, the detection filter needs to be operated for a relatively long time. Therefore, a regeneration mechanism such as an electrothermal heater for regenerating the detection filter by burning to remove the particulate matter deposited on the detection filter is ordinarily provided in the vicinity of the detection filter.

However, when such a regeneration mechanism is provided, the structure of the entire exhaust gas purifying apparatus becomes bulky, and portions having high temperatures increase. Thus, there occur inconveniences such that heat resistances of each part need to be enhanced or the distances between the each part and the detection filter needs to be large.

The embodiment of the present invention may provide a particulate matter sensor and exhaust gas purifying apparatus which be omitted a regeneration mechanism for regenerating a detection filter even though the detection filter operates for a long period of time.

A particulate matter sensor of the embodiment of the present invention detects particulate matter in an exhaust gas exhausted from an internal combustion engine, and includes an exhaust passage through which the exhaust gas flows, a detection filter installed in the exhaust passage and configured to detect (capture) the particulate matter contained in the exhaust gas passing through the exhaust passage, a differential pressure detecting unit configured to detect a pressure difference between an upstream side and a downstream side of the detection filter, an on-off valve installed on the upstream side of the detection filter in the exhaust passage and configured to permit and prohibit a flow of the exhaust gas toward the detection filter, and a valve control unit configured to control the on-off valve to be opened and closed.

In this embodiment of the invention, the on-off valve permitting or prohibiting a flow of the exhaust gas to the detection filter is installed on the upstream side of the detection filter capable of detecting (capturing) the particulate matter inside the exhaust passage through which the exhaust gas exhausted from the internal combustion engine flows. In a case where the on-off valve is opened, the flow of the exhaust gas onto the side of the detection filter is permitted, and the exhaust gas is guided to the detection filter. In a case where the on-off valve is closed, the flow of the exhaust gas onto the detection filter side from the exhaust passage is prohibited, and the exhaust gas is not guided to the detection filter. Therefore, it is possible to drastically reduce (limit) the amount of time during which the detection filter is exposed to the exhaust gas. Thus, a deposit rate of the particulate matter on the detection filter may be drastically lowered. As a result, a regeneration mechanism, which regenerates the detection filter in order to allow for long term operation, may be omitted.

In the particulate matter sensor of the embodiment, the valve control unit may control the on-off valve to be opened and closed at regular intervals.

In the particulate matter sensor of the embodiment, the valve control unit may control the on-off valve to be opened and closed based on an operation state of the internal combustion engine and a state of the exhaust gas.

The exhaust gas purifying apparatus of the embodiments of the present invention is installed in a an exhaust pipe (primary exhaust line) through which an exhaust gas flows, and includes a particulate matter capturing filter which captures the particulate matter contained in the exhaust gas further including the above-mentioned particulate matter sensor, an upstream side exhaust gas introducing unit configured to introduce a part of the exhaust gas flowing through the exhaust pipe (primary exhaust line) from the upstream side of the particulate matter capturing filter toward the particulate matter sensor, and a particulate matter deposit amount calculating unit configured to calculate the amount of the particulate matter depositing on the particulate matter capturing filter based on the amount of the particulate matter detected by the particulate matter sensor.

Another exhaust gas purifying apparatus of the embodiments of the present invention is installed in an exhaust pipe (primary exhaust line) through which an exhaust gas flows, and includes a particulate matter capturing filter which captures the particulate matter contained in the exhaust gas flowing through the exhaust pipe (primary exhaust line) further including a downstream side exhaust gas introducing unit configured to introduce a part of the exhaust gas flowing through the exhaust pipe (primary exhaust line) from the downstream side of the particulate matter capturing filter toward the particulate matter sensor, and a filter failure (trouble) diagnosing unit configured to diagnose the particulate matter capturing filter based on the amount of the particulate matter detected by the particulate matter sensor.

The above-mentioned exhaust gas purifying apparatus is an exhaust gas purifying apparatus applied with the above-mentioned particulate matter sensor.

A description of an exhaust gas purifying apparatus is given below, with reference to figures of the embodiment according to the present invention.

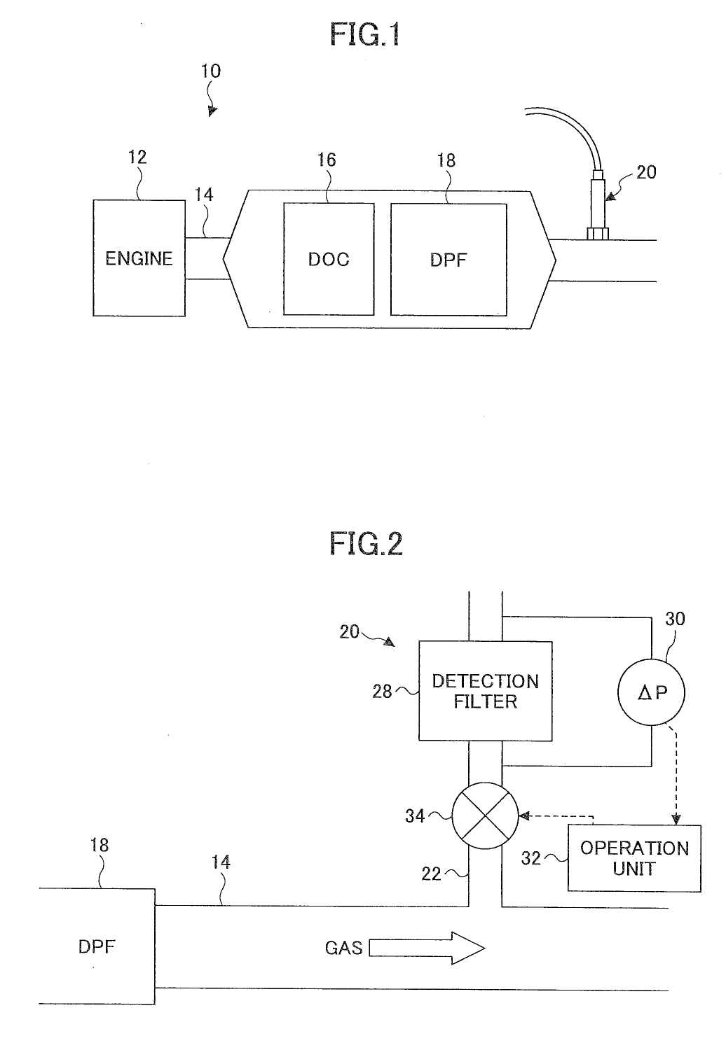

FIG. 1 illustrates an entire structure of an exhaust gas purifying apparatus 10 of the embodiment according to the present invention. FIG. 2 illustrates the structure of an important portion of the exhaust gas purifying apparatus 10 of FIG. 1.

As illustrated in FIG. 1, the exhaust gas purifying apparatus 10 of the embodiment includes a Diesel Oxidation Catalyst (DOC) 16 installed in an exhaust line 14, which is connected to an internal combustion engine 12, and a particulate matter capturing filter (diesel particulate filter (DPF)) 18. The DOC 16 is a catalyst (catalyst supporting carrier) for removing carbon monoxide, carbon hydride and the like, which are susceptible to oxidation and contained in an exhaust gas exhausted from an internal combustion engine 12. Meanwhile, the DPF 18 is a filter which may capture particulate matter contained in the exhaust gas exhausted from the internal combustion engine 12.

The exhaust gas purifying apparatus 10 of the embodiment is provided to purify the exhaust gas discharged to the atmosphere from the internal combustion engine 12. The exhaust gas purifying apparatus 10 of the embodiment may detect a failure (trouble) when the DPF 18 has the failure such as breakage thereby causing leakage of the particulate matter as much as a threshold value or more onto a downstream side of the DPF 18 of the exhaust line 14. The exhaust gas purifying apparatus 10 provides an alert about the failure, causes a lamp to blink, light up or the like when the failure is detected. The exhaust gas purifying apparatus 10 includes the particulate matter sensor 20 for detecting the failure of the DPF 18.

Referring to FIG. 2, an exhaust gas collection line 22 is connected to the primary exhaust line (exhaust line 14) on the downstream side of the DPF 18. The exhaust gas collection line 22 (see FIG. 2) and 104 (see FIG. 4) and the primary exhaust line (exhaust line 14) in this embodiment are typically and inclusively referred to as an exhaust passage in claims.

The exhaust gas collection line 22 branches off from the primary exhaust line (exhaust line 14). Therefore, a part of the exhaust gas passing through the DPF 18 may flow into the exhaust gas collection line 22.

The exhaust gas collection line 22 has a flow passage cross-sectional area smaller than that of the primary exhaust line (exhaust line 14). The flow passage cross-sectional area of the exhaust gas collection line 22 is, for example, about from one-hundredth up to one-thousandth of the flow passage cross-sectional area of the primary exhaust line (exhaust line 14).

The particulate matter sensor 20 is installed inside the exhaust gas collection line 22. It is determined whether the particulate matter leaks from the DPF 18 based on concentration of the particulate matter in the exhaust gas which flows through the exhaust gas collection line 22.

The particulate matter sensor 20 is made up of detection filter 28 installed inside the exhaust gas collection line 22 and a differential pressure gauge 30. Meanwhile, the particulate matter sensor 20 may be configured to further include a flow meter and/or a temperature measuring part. A downstream end of the exhaust gas collection line 22 is connected to a portion (e.g. a negative pressure tank, an air intake and the like) having a pressure lower than the pressure of an upstream side of the exhaust gas collection line 22. Therefore, a part of the exhaust gas inside the primary exhaust line (exhaust line 14) passing through the DPF 18 is branched off to a side of the exhaust gas collection line 22. Thus, the part of the exhaust gas passes through the detection filter 28.

The detection filter 28 is provided to calculate concentration of the particulate matter contained in the exhaust gas exhausted from the internal combustion engine 12. The detection filter 28 may capture the particulate matter, and may detect the particulate matter. The detection filter 28 is configured by a material similar to the DPF 18 such as a porous ceramic in a cylindrical shape. The detection filter 28 has a soot storage capacity smaller than that of the DPF 18.

The differential pressure gauge 30 outputs an electric signal corresponding to a differential pressure “ΔP” between an inlet and an outlet of the detection filter 28 (a pressure difference “ΔP” between the upstream side and the downstream side). For example, the differential pressure gauge 30 may be a known pressure gauge of a diaphragm type, a gauge type, a bellows type, a thermal type or the like. An operation unit 32 is electrically connected to the differential pressure gauge 30, mainly configured of a microcomputer. The output from the differential pressure gauge 30 is supplied to the operation unit 32. The operation unit 32 detects the pressure difference “ΔP” generated between the upstream side and the downstream side of the detection filter 28 inside the exhaust gas collection line 22. The differential pressure gauge 30 measures the concentration of the particulate matter in the exhaust gas based on a time change of the pressure difference “ΔP”.

An on-off valve 34 is installed in the exhaust gas collection line 22. For example, the on-off valve 34 is an electromagnetic valve or the like. The on-off valve 34 is installed in the exhaust gas collection line 22 between a branching point from the primary exhaust line (exhaust line 14) and the detection filter 28. The on-off valve 34 permits or prohibits a flow of the exhaust gas from the primary exhaust line (exhaust line 14) to the detection filter 28. The on-off valve 34 is electrically connected to the operation unit 32, which is mainly configured of the microcomputer. The on-off valve 34 opens or closes in accordance with a command from the operation unit 32. Specifically, the on-off valve 34 permits a flow of the exhaust gas from the primary exhaust line (exhaust line 14) to the detection filter 28 when an open command signal is supplied from the operation unit 32. Meanwhile, the on-off valve 34 is operated to prohibit the flow of the exhaust gas from the primary exhaust line (exhaust line 14) to the detection filter 28 in a case where a close command signal is supplied from the operation unit 32.

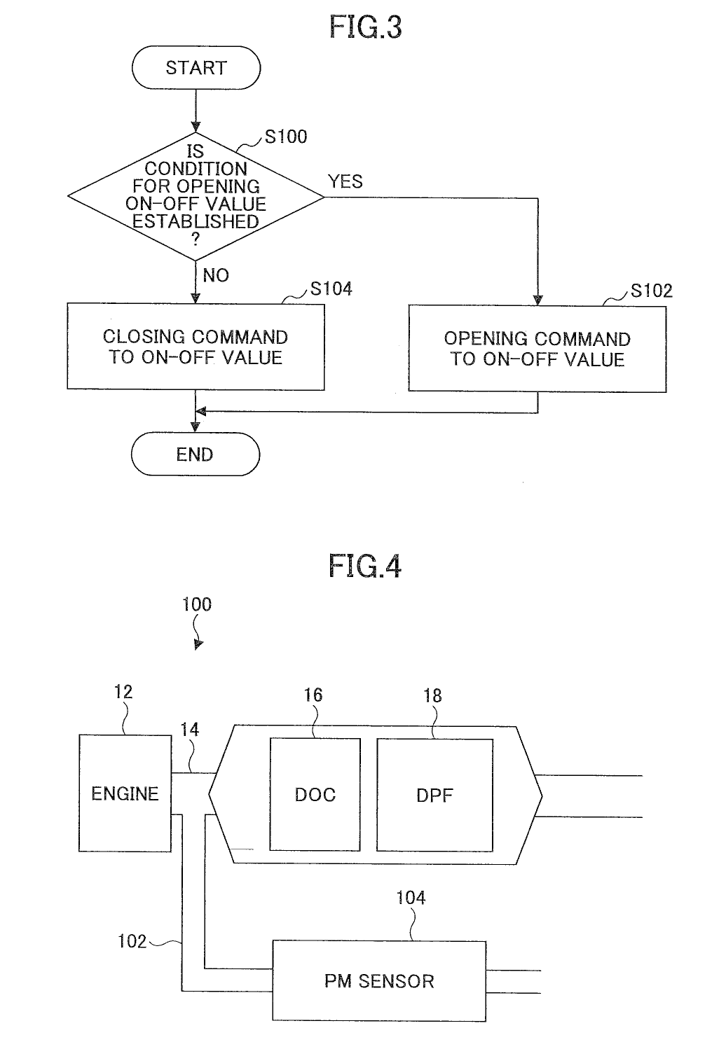

Referring to FIG. 3, operation of the exhaust gas purifying apparatus 10 of the embodiment is described. FIG. 3 is a flowchart illustrating a control routine of driving an on-off valve of the exhaust gas purifying apparatus of the embodiment, as an example.

In the embodiment, the exhaust gas exhausted from the internal combustion engine 12 flows inside the primary exhaust line (exhaust line 14), and passes through the DPF 18. Thereafter, the exhaust gas is discharged into the atmosphere or flows into the exhaust gas collection line 22. When the on-off valve 34 is closed to prohibit the exhaust gas from flowing from the primary exhaust line (exhaust line 14) to the detection filter 28, the exhaust gas flown into the exhaust gas collection line 22 is prohibited from flowing into a downstream side, i.e. the detection filter 28, of the on-off valve 34 in the exhaust gas collection line 22. On the other hand, when the on-off valve 34 is opened to permit the flow of the exhaust gas from the primary exhaust line (exhaust line 14) to the detection filter 28, the exhaust gas is permitted to flow into the downstream side, i.e. the detection filter 28, of the on-off valve 34 in the exhaust gas collection line 22.

When the exhaust gas is permitted to flow into the detection filter 28, the exhaust gas is guided to the detection filter 28. When the particulate matter is contained in the exhaust gas, the particulate matter is absorbed by the detection filter 28 and deposits on the detection filter 28. When a state in which the particulate matter deposits on the detection filter 28 changes over a period of time, the pressure difference “ΔP” before and after the detection filter 28 in the exhaust gas collection line 22 changes over the same period of time.

The operation unit 32 detects the pressure difference “ΔP” generated between the upstream side and the downstream side of the detection filter 28 in the exhaust gas collection line 22 based on the output signal of the differential pressure gauge 30 during the time which the exhaust gas is permitted by the on-off filter 34 to flow into the detection filter 28. The operation unit 32 calculates the amount of the particulate matter detected (captured) by the detection filter 28 based on the time change of the pressure difference “ΔP”, and calculates the concentration of the particulate matter in the exhaust gas flowing through the exhaust gas collection line 22. The operation unit 32 determines existence of the leakage from the DPF 18 based on whether the calculated concentration of the particulate matter is a threshold value or more. When the existence of the leakage of the particulate matter from the DPF 18 is determined as the result of the determination, the exhaust gas purifying apparatus 10 provides an alert about the failure, causes a lamp to blink, light up and the like.

Thus, under the situation where the flow of the exhaust gas to the detection filter is permitted by the on-off valve 34, the differential pressure gauge 30 is used in determining the existence of the failure of the DPF 18 by calculating the concentration of the particulate matter in the exhaust gas on the downstream side of the DPF 18. Therefore, it is possible to report the failure to a driver of a vehicle having the exhaust gas purifying apparatus installed in it when the failure is determined.

The operation unit 32 may supply an open command signal to the on-off valve 34 at regular intervals not constantly. The open command signal may be supplied when the internal combustion engine 12 is driven at a revolution number as large as a predetermined revolution number or more. Specifically, in step S102 following YES of step S100, the open command signal is supplied to the on-off valve 34 for a second predetermined time (e.g. about 1 second through about 30 seconds) shorter than a first predetermined time (e.g. about 5 through about 20 minutes during operation of the internal combustion engine) at every first predetermined time in step S102. In step S104 following NO of step S100, the close command signal is supplied to the on-off valve 34. When the internal combustion engine 12 is driven at about 2000 rpm or more (YES of step S100), the open command signal is supplied to the on-off valve 34 in step S102. When the internal combustion engine 12 is driven at less than about 2000 rpm (NO of step S100), the close command signal is supplied to the on-off valve 34 in step S104. In this case, the flow of the exhaust gas into the detection filter 28 via the exhaust gas collection line 22 is not always permitted. It is permitted only in a case where a condition of opening the on-off valve 32 is established.

A duration time between starting to supply the open command signal to the on-off valve 34 and ending of the supply (e.g. the above second predetermined time) may be as follows. The operation unit 32 calculates at least concentration of the particulate matter in the exhaust gas flowing through the exhaust gas collection line 22. Then, the duration time is set to be the minimum necessary time for determining the existence of the leakage of the particulate matter from the DPF 18 based on the concentration of the particulate matter.

In the exhaust gas purifying apparatus 10, it is possible to limit a time while the detection filter 28 is exposed to the exhaust gas by closing the on-off valve 34 in comparison with a case where the detection filter 28 is constantly exposed to the exhaust gas. The more the condition of permitting the flow of the exhaust gas into the detection filter 28 is relaxed (the shorter the first predetermined time or the longer the second predetermined time), the less the time is limited. Therefore, the leakage of the particulate matter is determined at the higher frequency. The more the condition of permitting the flow of the exhaust gas into the detection filter 28 is strict (the longer the first predetermined time or the shorter the second predetermined time), the more the time is limited. Therefore, the time is relatively shortened to thereby facilitate restriction of the frequency of determining the leakage of the particulate matter from the DPF 18.

According to the embodiment, when the frequency of determining the leakage of the particulate matter from the DPF 18 can be restricted, the condition of opening the on-off valve 32 may be strictly set. Then, it is possible to drastically facilitate reducing a deposit rate that the particulate matter in the exhaust gas deposits on the detection filter 28. Therefore, regeneration of the detection filter 28 after removing the deposited particulate matter may be omitted in properly operating the detection filter 28 for a long time. Further, a regeneration mechanism for regenerating the detection filter 28 may be omitted.

Therefore, it is possible to reduce the size of an entire structure of the exhaust gas purifying apparatus 10 of the Embodiment. Further, the number of parts required to enhance heat resistance may be decreased. Thus, it is possible to easily configure the exhaust gas purifying apparatus 10 which is capable of determining the leakage of the particulate matter from the DPF 18 at a low cost.

As described, the preferred embodiment of the present invention has been described. However, the embodiments of the present invention are not limited to the specific embodiment, and various modifications and changes are possible in the scope of claims.

For example, in the embodiment, the determination of the leakage of the particulate matter from the DPF 18 and the supply of the opening or closing commands to the on-off valve 34 are carried out by the same operation unit 32. Instead, it is possible to carry out the determination and the supply of the opening or closing commands by different operation units.

In the embodiment, the on-off valve is opened at the regular intervals or when the internal combustion engine 12 is driven at a revolution number as large as the predetermined value or more. However, the embodiments of the present invention are not limited to the embodiment. For example, the on-off valve 34 may be closed when the internal combustion engine 12 is started or runs idle, and opened under other situations. Further, a temperature sensor may be provided to detect the temperature of the exhaust gas, and the on-off valve 34 is closed when the temperature of the exhaust gas is lower than the predetermined value. Under the other situations, the on-off valve 34 may be closed. Moreover, the on-off valve 34 may be opened at regular intervals and when the internal combustion engine 12 is driven at a revolution number as large as a predetermined revolution number or more.

Further, the embodiment is related to the system of the exhaust gas purifying apparatus 10 which includes the exhaust gas collection line 22 connected to the downstream side of the DPF 18 in the primary exhaust line (exhaust line 14), and the particulate matter sensor 20 inside the exhaust gas collection line 22. The exhaust gas purifying apparatus 10 determines the leakage of the particulate matter from the DPF 18 based on the amount of the particulate matter detected (captured) by the particulate matter sensor 20. However, the embodiment of the present invention is not limited thereto.

As illustrated in FIG. 4, an exhaust gas collection line 102 may be provided on an upstream side of the DPF 18 in the primary exhaust line (exhaust line 14). Then, a particulate matter sensor 104 may be installed in the exhaust gas collection line 102. The concentration of the particulate matter in the exhaust gas flowing through the primary exhaust line (exhaust line 14) or the amount of the particulate matter depositing on the DPF 18 is measured based on the amount of the particulate matter detected (captured) by the particulate matter sensor 104. Such structures may be applied to the system of the exhaust gas purifying apparatus 100.

In this case, the upstream side of the exhaust gas collection line 102 is connected to the upstream side of the DPF 18 in the primary exhaust line (exhaust line 14), and the downstream side of the exhaust gas collection line 102 may be connected to the downstream side of the DPF 18.

In this modified example, an on-off valve 106 for permitting and prohibiting flow of the exhaust gas from the primary exhaust line (exhaust line 14) to the detection filter (not illustrated but existing inside the particulate matter sensor 104) may be installed in the exhaust gas collection line 102. Further, an operation unit for commanding to open or close the on-off valve 106 at a proper timing described in the above embodiment may be provided. In this case, it becomes possible to restrict a time while the detection filter is exposed to the exhaust gas may be restricted by closing the on-off valve 106. Therefore, it is possible to obtain effects similar to those of the above embodiment.

Obviously, numerous modifications and variations of the present invention are possible in light of the above teachings. It is therefore to be understood that within the scope of the appended claims, the invention may be practiced otherwise than as specifically described herein.

What is claimed is:

1. A particulate matter sensor comprising:
a detection filter that is installed in an exhaust passage connected to an internal combustion engine and that is configured to detect particulate matter contained in an exhaust gas passing through the exhaust passage;
a differential pressure detecting unit configured to detect a pressure difference between an upstream side and a downstream side of the detection filter;
an on-off valve installed on the upstream side of the detection filter in the exhaust passage and configured to control a flow of the exhaust gas toward the detection filter; and
a valve control unit configured to control the on-off valve to be opened and closed.

2. The particulate matter sensor according to claim 1,
wherein the valve control unit is configured to control the on-off valve to be opened and closed at regular intervals.

3. The particulate matter sensor according to claim 1,
wherein the valve control unit is configured to control the on-off valve to be opened and closed based on an operation state of the internal combustion engine and a state of the exhaust gas.

4. The particulate matter sensor according to claim 1,
wherein the detection filter comprises a porous ceramic.

5. The particulate matter sensor according to claim 1,
wherein the detection filter is in a cylindrical shape.

6. The particulate matter sensor according to claim 1, further comprising:
at least one of a flow meter and a temperature measuring part.

7. An exhaust gas purifying apparatus comprising:
the particulate matter sensor according to claim 1;
a particulate matter capturing filter configured to capture particulate matter contained in an exhaust gas flowing through a primary exhaust line included in an exhaust passage;
an upstream side exhaust gas introducing unit configured to introduce a part of the exhaust gas flowing through the primary exhaust line from an upstream side of the particulate matter capturing filter toward the particulate matter sensor; and
a particulate matter deposit amount calculating unit configured to calculate an amount of the particulate matter depositing on the particulate matter capturing filter based on an amount of the particulate matter detected by the particulate matter sensor.

8. The exhaust gas purifying apparatus according to claim 7,
wherein the valve control unit is configured to control the on-off valve to be opened and closed at regular intervals.

9. The exhaust gas purifying apparatus according to claim 7,
wherein the valve control unit is configured to control the on-off valve to be opened and closed based on an operation state of the internal combustion engine and a state of the exhaust gas.

10. The exhaust gas purifying apparatus according to claim 7,
wherein the detection filter comprises a porous ceramic.

11. The exhaust gas purifying apparatus according to claim 7,
wherein the detection filter is in a cylindrical shape.

12. The exhaust gas purifying apparatus according to claim 7, further comprising:
at least one of a flow meter and a temperature measuring part.

13. The exhaust gas purifying apparatus according to claim 7,
wherein the detection filter comprises a soot storage capacity smaller than a soot storage amount of the particulate matter capturing filter.

14. The exhaust gas purifying apparatus according to claim 7,
wherein when an amount of the particulate matter leaking onto the downstream side of the detection filter in the exhaust passage is a threshold value or more, an alert becomes active, a lamp blinks, or the lamp lights.

15. The exhaust gas purifying apparatus according to claim 7,
wherein the upstream side exhaust gas introducing unit has a flow passage cross-sectional area smaller than a flow passage cross-sectional area of the primary exhaust line.

16. The exhaust gas purifying apparatus according to claim 7,
wherein an end opposite to an upstream side of the particulate matter capturing filter in the upstream side exhaust gas introducing unit is connected to a portion having a pressure lower than a pressure at a position where the upstream side exhaust gas introducing unit introduces the part of the exhaust gas from the primary exhaust line.

17. The exhaust gas purifying apparatus according to claim 16,
wherein the portion comprises at least one of a negative pressure tank and an air intake.

18. The exhaust gas purifying apparatus according to claim 7,
wherein the upstream side exhaust gas introducing unit has a flow passage cross-sectional area about one-hundredth through about one-thousandth of a flow passage cross-sectional area of the primary exhaust line.

19. The exhaust gas purifying apparatus according to claim 7,
wherein an open command signal is supplied to the on-off valve at regular intervals.

20. The exhaust gas purifying apparatus according to claim 7,
wherein an open command signal is supplied to the on-off valve when the internal combustion engine is driven at a predetermined revolution number or more.

21. The exhaust gas purifying apparatus according to claim 19,
wherein the open command signal is supplied to the on-off valve for a predetermined time shorter than a first predetermined time at every first predetermined time, and a close command signal is supplied to the on-off valve for a time other than the predetermined time.

22. The exhaust gas purifying apparatus according to claim 20,
wherein when the internal combustion engine is driven at 2000 rpm or more, the open command signal is supplied to the on-off valve, and when the internal combustion engine is driven at less than about 2000 rpm, the close command signal is supplied to the on-off valve.

23. The exhaust gas purifying apparatus according to claim 7,
wherein the on-off valve is closed when the internal combustion engine is started or runs idle, and otherwise the on-off valve is opened.

24. The exhaust gas purifying apparatus according to claim 7, further comprising:
a temperature sensor configured to detect a temperature of the exhaust gas,
wherein the on-off valve is closed when the temperature of the exhaust gas is equal to or less than a predetermined value, and otherwise the on-off valve is closed.

25. The exhaust gas purifying apparatus according to claim 7,
wherein the on-off valve is opened at regular intervals, and is further opened when the international combustion engine is rotated at a predetermined value or more.

26. An exhaust gas purifying apparatus comprising:
the particulate matter sensor according to claim 1;
a particulate matter capturing filter configured to capture particulate matter contained in an exhaust gas flowing through a primary exhaust line included in an exhaust passage;
a downstream side exhaust gas introducing unit configured to introduce a part of the exhaust gas flowing through the primary exhaust line from a downstream side of the particulate matter capturing filter toward the particulate matter sensor; and
a filter failure diagnosing unit configured to diagnose the particulate matter capturing filter based on an amount of the particulate matter detected by the particulate matter sensor.

27. The particulate matter sensor according to claim 26,
wherein the valve control unit is configured to control the on-off valve to be opened and closed at regular intervals.

28. The particulate matter sensor according to claim 26,
wherein the valve control unit is configured to control the on-off valve to be opened and closed based on an operation state of the internal combustion engine and a state of the exhaust gas.

29. The particulate matter sensor according to claim 26,
wherein the detection filter comprises a porous ceramic.

30. The particulate matter sensor according to claim 26,
wherein the detection filter is in a cylindrical shape.

31. The particulate matter sensor according to claim 26, further comprising:
at least one of a flow meter and a temperature measuring part.

32. The exhaust gas purifying apparatus according to claim 26,
wherein the detection filter has a soot storage capacity smaller than a soot storage amount of the particulate matter capturing filter.

33. The exhaust gas purifying apparatus according to claim 26,
wherein when an amount of the particulate matter leaking onto the downstream side of the detection filter in the exhaust passage is a threshold value or more, an alert becomes active, a lamp blinks, or the lamp lights.

34. The exhaust gas purifying apparatus according to claim 26,
wherein the downstream side exhaust gas introducing unit has a flow passage cross-sectional area smaller than a flow passage cross-sectional area of the primary exhaust line.

35. The exhaust gas purifying apparatus according to claim 26,
wherein an end opposite to a downstream side of the particulate matter capturing filter in the downstream side exhaust gas introducing unit is connected to a portion having a pressure lower than a pressure at a position where the downstream side exhaust gas introducing unit introduces the part of the exhaust gas from the primary exhaust line.

36. The exhaust gas purifying apparatus according to claim 35,
wherein the portion comprises at least one of a negative pressure tank and an air intake.

37. The exhaust gas purifying apparatus according to claim 26,
wherein the downstream side exhaust gas introducing unit has a flow passage cross-sectional area about one-hundredth through about one-thousandth of a flow passage cross-sectional area of the primary exhaust line.

38. The exhaust gas purifying apparatus according to claim 19,
wherein an open command signal is supplied to the on-off valve at regular intervals.

39. The exhaust gas purifying apparatus according to claim 27,
wherein an open command signal is supplied to the on-off valve when the internal combustion engine is driven at a predetermined revolution number or more.

40. The exhaust gas purifying apparatus according to claim 38,
wherein the open command signal is supplied to the on-off valve for a predetermined time shorter than a first predetermined time at every first predetermined time, and a close command signal is supplied to the on-off valve for a time other than the predetermined time.

41. The exhaust gas purifying apparatus according to claim 39,
wherein when the internal combustion engine is driven at 2000 rpm or more, the open command signal is supplied to the on-off valve, and when the internal combustion engine is driven at less than about 2000 rpm, the close command signal is supplied to the on-off valve.

42. The exhaust gas purifying apparatus according to claim 26,
wherein the on-off valve is closed when the internal combustion engine is started or runs idle, and otherwise the on-off valve is opened.

43. The exhaust gas purifying apparatus according to claim 26, further comprising:
a temperature sensor configured to detect a temperature of the exhaust gas,
wherein the on-off valve is closed when the temperature of the exhaust gas is equal to or less than a predetermined value, and otherwise the on-off valve is closed.

44. The exhaust gas purifying apparatus according to claim 26,
wherein the on-off valve is opened at regular intervals, and is further opened when the international combustion engine is rotated at a predetermined value or more.
